(19) United States
(12) Patent Application Publication
(10) Pub. No.: US 2019/0350189 A1
(43) Pub. Date: Nov. 21, 2019

(54) VEGETATION SAW ASSEMBLY

(71) Applicant: Mark Skief, Gillespie, IL (US)

(72) Inventor: Mark Skief, Gillespie, IL (US)

(21) Appl. No.: 15/985,219

(22) Filed: May 21, 2018

(51) Int. Cl. A01M 21/02

(52) U.S. Cl. CPC A01M 21/02

(57) ABSTRACT

A vegetation saw assembly for sawing a root system of an undesired plant includes a pole and a mount that is attachable to the pole. A blade is coupled to the mount and the blade is extendable underground and is positionable between a desired plant and an undesired plant. The blade has a distal end with respect to the mount and the blade is concavely arcuate between the mount and the distal end of the blade. In this way the blade may saw a root system of the undesired plant at an approximately horizontal angle when the blade is extended underground for removing the undesired plant.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98.

The disclosure and prior art relates to saw devices and more particularly pertains to a new saw device for sawing a root system of an undesired plant.

### BRIEF SUMMARY OF THE INVENTION

An embodiment of the disclosure meets the needs presented above by generally comprising a pole and a mount that is attachable to the pole. A blade is coupled to the mount and the blade is extendable underground and is positionable between a desired plant and an undesired plant. The blade has a distal end with respect to the mount and the blade is concavely arcuate between the mount and the distal end of the blade. In this way the blade may saw a root system of the undesired plant at an approximately horizontal angle when the blade is extended underground for removing the undesired plant.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a vegetation saw assembly according to an embodiment of the disclosure.

FIG. 2 is a top perspective view of blade and a mount of an embodiment of the disclosure.

FIG. 3 is a right side view of blade and a mount of an embodiment of the disclosure.

FIG. 4 is a perspective in-use view of an embodiment of the disclosure.

### DETAILED DESCRIPTION OF THE INVENTION

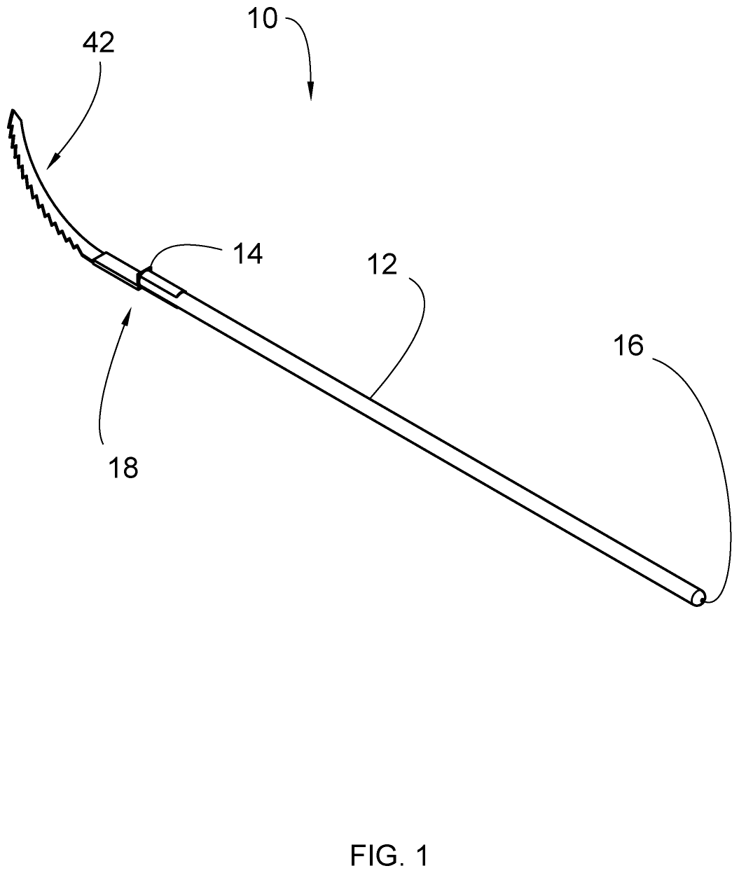

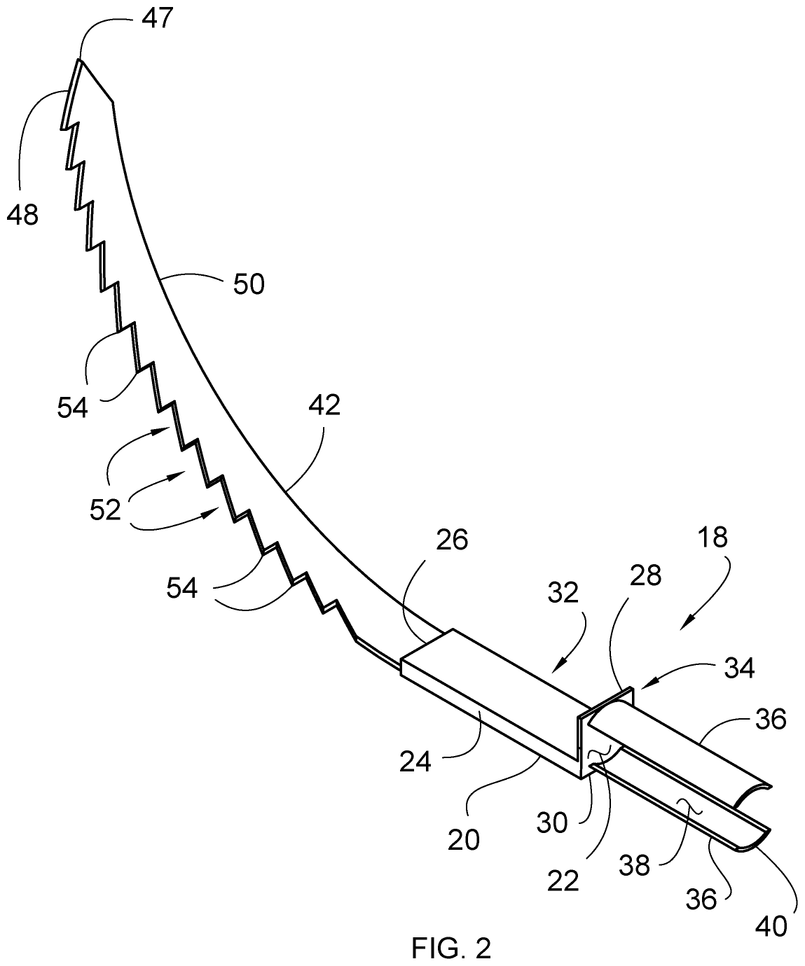

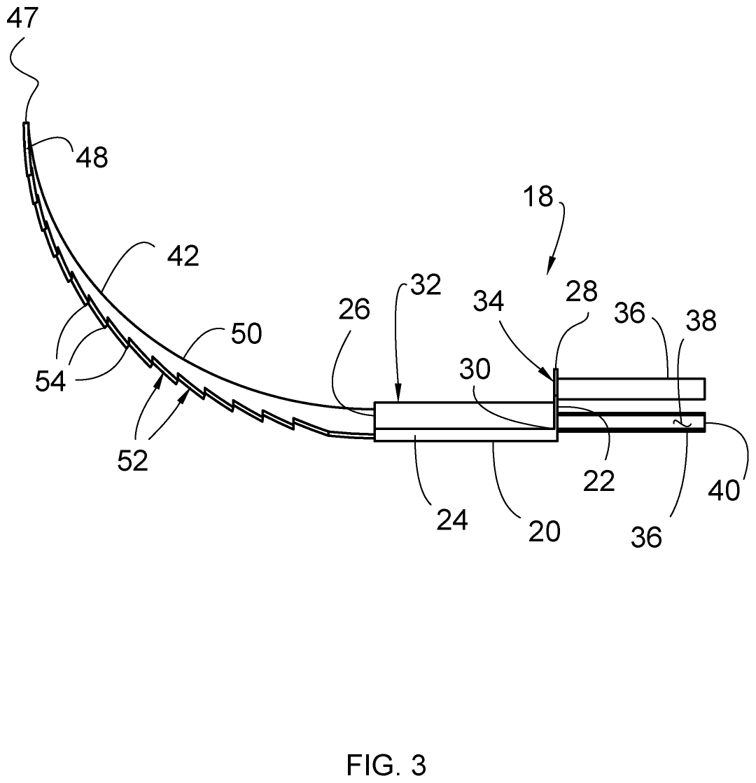

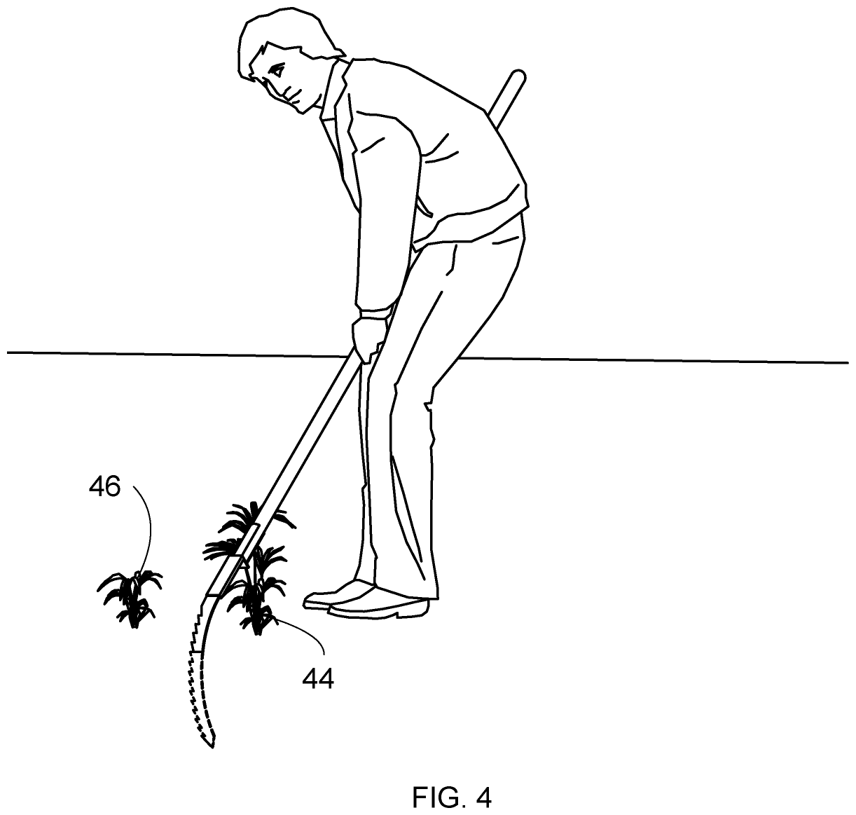

With reference now to the drawings, and in particular to FIGS. 1 through 4 thereof, a new saw device embodying the principles and concepts of an embodiment of the disclosure and generally designated by the reference numeral 10 will be described.

As best illustrated in FIGS. 1 through 4, the vegetation saw assembly 10 generally comprises a pole 12 that has a first end 14 and a second end 16. The pole 12 may be a shovel handle or other similar elongated pole 12. A mount 18 is provided and the mount 18 is attachable to the pole 12. The mount 18 comprises a panel 20 that has a first surface 22 and a peripheral edge 24, and the peripheral edge 24 has a front side 26 and a back side 28. The panel 20 has a bend 30 thereon to define a first portion 32 of the panel 20 forming an angle with the second portion 34 of the panel 20. The bend 30 is oriented to extend in the same direction as each of the front side 26 and the back side 28 and the bend 30 is positioned closer to the back side 28 than the front side 26.

The mount 18 includes a pair of members 36 and each of the members 36 is attached to and extends away from the first surface 22 of the second portion 34 of the panel 20. Each of the members 36 has a primary surface 38 and a distal end 40 with respect to the second portion 34 of the panel 20. Moreover, the primary surface 38 of each of the members 36 is concavely arcuate. The members 36 are spaced apart from each other for insertably receiving the first end 14 of the pole 12. Additionally, the pair of member is oriented such that the first surface 22 of each of the members 36 faces each other. In this way each of the members 36 forms a respective segment of a circle when the members 36 are viewed from the distal end 40 of the members 36 for conforming to a curvature of the pole 12.

A blade 42 is coupled to the mount 18 and the blade 42 is extendable underground. Additionally, the blade 42 is positionable between a desired plant 44 and an undesired plant 46 in a garden, a yard and any other cultivated area with plants. The blade 42 has a distal end 47 with respect to the mount 18 and the blade 42 is concavely arcuate between the mount 18 and the distal end 47 of the blade 42. In this way the blade 42 may saw a root system of the undesired plant 46 at an approximately horizontal angle when the blade 42 is extended underground. Thus, the undesired plant 46 may be removed without disturbing the desired plant 44.

The blade 42 is positioned on the front side 26 of the mount 18 and is oriented co-linear with the first portion 32 of the mount 18. The blade 42 has a first edge 48 and a second edge 50, and the second edge 50 has a plurality of indentations 52 extending towards the first edge 48. The indentations 52 are spaced apart from each other and are distributed between the front side 26 of the mount 18 and the distal end 47 of the blade 42. Thus, a plurality of teeth 54 is defined to facilitate the blade 42 to saw the root system of the undesired plant 46.

In use, the pole 12 is inserted between each of the members 36 and a fastener, such as a screw of the like, is extended through one of the members 36 to engage the pole 12 thereby retaining the pole 12 between the members 36. The distal end 47 of the blade 42 is positioned between the desired plant 44, such as flower or the like, and the undesired plant 46, such as a weed or the like. Moreover, the blade 42 is urged underground such that the blade 42 is positioned between the root systems of the desired plant 44 and the undesired plant 46. The curvature of the blade 42 facilitates a portion of the blade 42 to be oriented at an approximate horizontal angle in spite of the approximately vertical angle at which the pole 12 is oriented. The pole 12 is urged back and forth thereby facilitating the teeth 54 on the blade 42 to saw through the root system of the undesired plant 46 without disturbing the root system of the desired plant 44. In this way the undesired plant 46 is eliminated for the purposes of weeding a garden or a yard.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vegetation saw assembly being configured to be extended underground for sawing a root system from a plant thereby facilitating the plant to be eliminated, said assembly comprising:
a pole;
a mount being attachable to said pole; and
a blade being coupled to said mount wherein said blade is configured to be extended underground and being positioned between a desired plant and an undesired plant, said blade having a distal end with respect to said mount, said blade being concavely arcuate between said mount and said distal end of said blade wherein said blade is configured to saw a root system of the undesired plant at an approximately horizontal angle when said blade is extended underground for removing the undesired plant.

2. The assembly according to claim 1, wherein said mount comprises a panel having a first surface and a peripheral edge, said peripheral edge having a front side and a back side, said panel having a bend thereon to define a first portion of said panel forming an angle with the second portion of said panel, said bend being oriented to extend in the same direction as each of said front side and said back side, said bend being positioned closer to said back side than said front side.

3. The assembly according to claim 2, wherein said mount comprises a pair of members, each of said members being attached to and extending away from said first surface of said second portion of said panel, each of said members having a primary surface and a distal end with respect to said second portion of said panel, said primary surface of each of said members being concavely arcuate.

4. The assembly according to claim 3, wherein:
said pole has a first end; and
said members are spaced apart from each other for insertably receiving said first end of said pole, said pair of member being oriented such that said first surface of each of said members faces each other such that each of members forms a respective segment of a circle viewed along a line extending through said distal end of said members and said second portion of said panel for conforming to a curvature of said pole.

5. The assembly according to claim 2, wherein said blade is positioned on said front side of said mount and being oriented co-linear with said first portion of said mount, said blade having a first edge and a second edge.

6. The assembly according to claim 5, wherein said second edge has a plurality of indentations extending towards said first edge, said indentations being spaced apart from each other and being distributed between said front side of said mount and said distal end of said blade to define a plurality of teeth wherein said blade is configured to saw the root system.

7. A vegetation saw assembly being configured to be extended underground for sawing a root system from a plant thereby facilitating the plant to be eliminated, said assembly comprising:
a pole having a first end and a second end;
a mount being attachable to said pole, said mount comprising:
a panel having a first surface and a peripheral edge, said peripheral edge having a front side and a back side, said panel having a bend thereon to define a first portion of said panel forming an angle with the second portion of said panel, said bend being oriented co-linear with each of said front side and said back side, said bend being positioned closer to said back side than said front side; and
a pair of members, each of said members being attached to and extending away from said first surface of said second portion of said panel, each of said members having a primary surface and a distal end with respect to said second portion of said panel, said primary surface of each of said members being concavely arcuate, said members being spaced apart from each other for insertably receiving said first end of said pole, said pair of member being oriented such that said first surface of each of said members faces each other such that each of said members forms a respective segment of a circle viewed along a line extending through said distal end of said members and said second portion of said panel for conforming to a curvature of said pole; and
a blade being coupled to said mount wherein said blade is configured to be extended underground and being positioned between a desired plant and an undesired plant, said blade having a distal end with respect to said mount, said blade being concavely arcuate between said mount and said distal end of said blade wherein said blade is configured to saw a root system of the undesired plant at an approximately horizontal angle when said blade is extended underground for removing the undesired plant, said blade being positioned on said front side of said mount and being oriented co-linear with said first portion of said mount, said blade having a first edge and a second edge, said second edge having a plurality of indentations extending towards said first edge, said indentations being spaced apart from each other and being distributed between said front side of said mount and said distal end of said blade to define a plurality of teeth wherein said blade is configured to saw the root system.
